(19) United States
(12) Patent Application Publication
(10) Pub. No.: US 2025/0307353 A1
(43) Pub. Date: Oct. 2, 2025

(54) AUTOMATED UNIT OF MEASURE VALIDATION SYSTEM FOR WELL SYSTEMS

(71) Applicant: Halliburton Energy Services, Inc., Houston, TX (US)

(72) Inventors: Andreas Sadlier, Houston, TX (US); Alexander Simon Chretien, Houston, TX (US); Beth Reidy, Houston, TX (US); Tabassum J. Qureshi, Houston, TX (US); Daniel Antonio, Houston, TX (US)

(21) Appl. No.: 18/619,698

(22) Filed: Mar. 28, 2024

(51) Int. Cl. G06F 18/22; G06F 18/21

(52) U.S. Cl. CPC G06F 18/22; G06F 18/2193

(57) ABSTRACT

Systems, methods, and apparatus, including computer programs encoded on computer-readable media, for validating well system measurements. Sample datasets for a plurality of measurement channels of a first channel set are obtained from one or more well devices of a well system. A comparison operation is performed of a first sample dataset associated with a first sample unit of measure of a first measurement channel of a first channel set with historical datasets of one or more historical units of measure of one or more matched historical measurement channels. A frequency of occurrence operation is performed for the first sample unit of measure and the one or more historical units of measure across the plurality of measurement channels of the first channel set. A validation process is performed based on the comparison operation or the frequency of occurrence operation, or both the comparison operation and the frequency of occurrence operation.

### TECHNICAL FIELD

The present invention relates generally to oil and gas systems and services, and more specifically to an automated unit of measure validation system for well systems.

### BACKGROUND

Well systems at well sites typically collect measurement data from well site equipment, sensors, downhole tools, and other well devices. The collected measurement data can have incorrect or missing unit of measure (UoM) information. The UoM for time and depth series data obtained by the well system needs to be accurate in order to make automated and algorithmic decisions by the well system. Mislabeled, incorrect, or missing UoM information may result in rework or the data may be unusable. Mislabeled, incorrect or missing UoM information may introduce risk of making incorrect calculations and downstream decisions. The use of real-time algorithms and analytics for live job decisions at well sites is increasing and thus accurate UoM information for service reliability is necessary. Invalid or missing UoM information may result in financial penalties if incorrect data is delivered to customers that result in incidents or rework. Invalid or missing UoM information may hinder automation initiatives at well sites and may impact the accuracy of artificial intelligence (AI) and machine learning (ML) algorithmic decisions.

### BRIEF DESCRIPTION OF THE DRAWINGS

FIG. 1 depicts a schematic diagram of an example well system including an automated unit of measure validation system, according to some implementations.

FIG. 2 is a flowchart of example operations for implementing an automated unit of measure management and validation system, according to some implementations.

FIG. 3 is a continuation of the flowchart from FIG. 2 that includes example operations for implementing an automated unit of measure management and validation system, according to some implementations.

FIG. 4 is a flowchart of example operations for implementing an automated unit of measure management and validation system, according to some implementations.

FIG. 5 depicts an example computer system that can be implemented in surface equipment of a well system for implementing an automated unit of measure management and validation system, according to some implementations.

FIG. 6 is a schematic diagram of a drilling rig system as an example of oil services systems that use surface and downhole equipment, according to some implementations.

### DESCRIPTION

The description that follows includes example systems, methods, techniques, and program flows that describe aspects of the disclosure. However, it is understood that this disclosure may be practiced without these specific details. For instance, this disclosure refers to certain well systems, devices, or tools in illustrative examples. Aspects of this disclosure can be instead applied to other types of well systems, devices, and tools. In other instances, well-known instruction instances, protocols, structures, and techniques have not been shown in detail to avoid confusion.

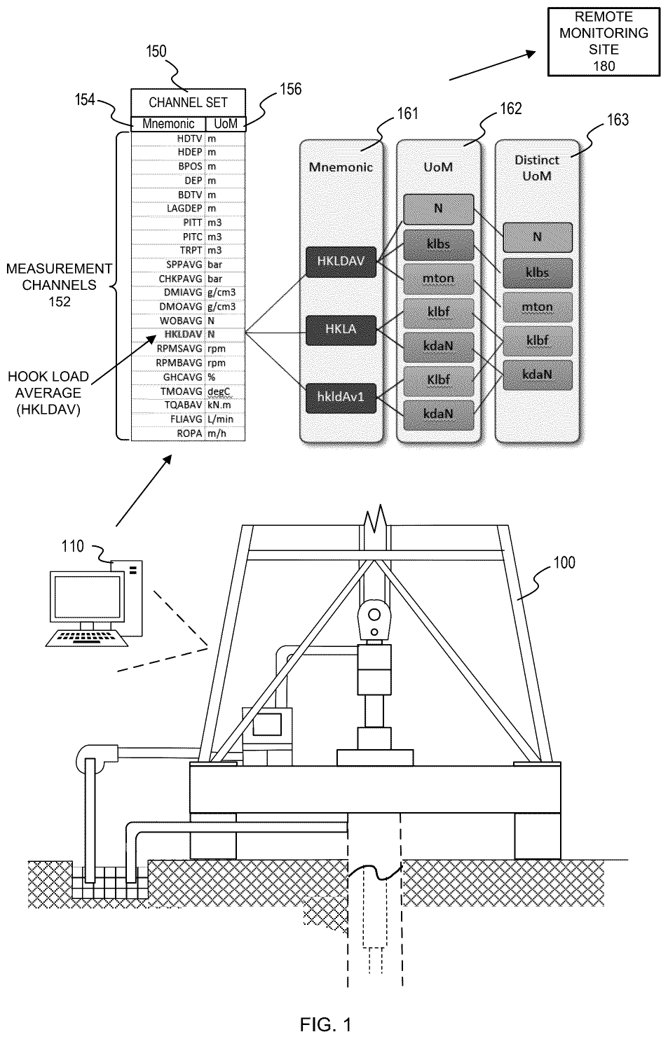

FIG. 1 depicts a schematic diagram of an example well system 100 including an automated unit of measure validation system, according to some implementations. The well system 100 may be any type of well system, such as a production or completion well system. The well system 100 may include various well devices, equipment, and tools that obtain both downhole and above ground measurements for the well system 100. In some implementations, the well system 100 may obtain sample measurement datasets for multiple measurement channels of multiple channel sets. The sample measurement datasets may be time or depth series-indexed datasets for the well system 100 that can be defined in channels, which may be referred to as measurement channels. The measurement channels may also be described as measurement curves. Each measurement channel (or curve) may include a measurement mnemonic, name or descriptor that describes the purpose of the measurement and a unit of measure (UoM) for the measured values. In some implementations, multiple measurement channels can be grouped in a channel set, which may also be referred to as a record or log. For example, multiple measurement channels that are compatible measurements can be grouped together in the same channel set. The series-indexed datasets (time- and/or depth-based) of various well-related phenomenon or metrics may be recorded across various well systems at well sites that perform various oil and gas service activities. After each well system obtains the datasets, the datasets may be recorded in a historical database locally at the well site and/or at one or more remote locations, such as a remote monitoring site 180. The remote monitoring site 180 may be a remote operator or customer site and/or a cloud-based server network that is accessible by the operator and customer, where the operator and/or customer can collect datasets from multiple well sites. Depending on the geographic or regional location of the well sites, the measurements of the same phenomenon may be identified by different mnemonics and may be recorded using various UoMs, as shown in FIG. 1 and described further below.

In the example shown in FIG. 1, the well system 100 may obtain sample measurement datasets for multiple measurement channels of multiple channel sets, including the measurement channels 152 of the channel set 150. For example, the well system 100 may use one or more well devices or tools (e.g., such as various surface or downhole sensors) to obtain the sample measurement datasets. In some implementations, the computer system 110 of the well system may obtain and store the measurement datasets for each measurement channel of each channel set. Although not shown for simplicity, the well system 100 may obtain sample measurement datasets for multiple channel sets, including a first set of measurement channels (such as measurement channels 152) for a first channel set (such as channel set 150), a second set of measurement channels for a second channel set (not shown), a third set of measurement channels for a third channel set (not shown), and so on. As shown in FIG. 1, each measurement channel 152 (i.e., each row in the chart) may include a measurement mnemonic 154 (i.e., the first column of the chart) and a unit of measure (UoM) 156 (i.e., the second column of the chart). Similarly, each measurement channel of each of the other channel sets may include a measurement mnemonic and a UoM. In some implementations, in addition to storing the measurement datasets, the computer system 110 may provide the measurement datasets to the remote monitoring site 180.

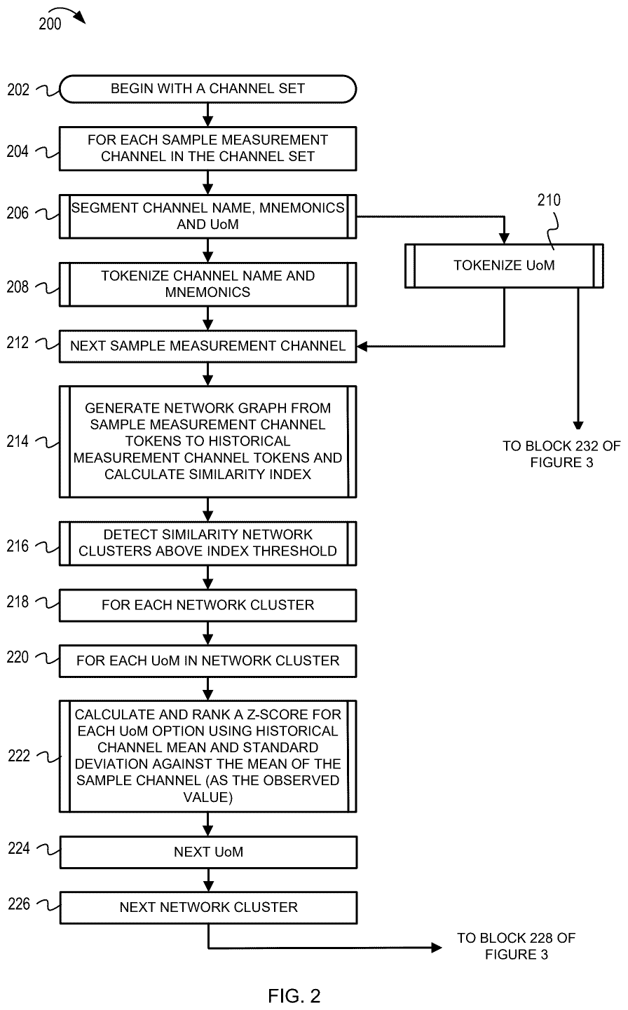

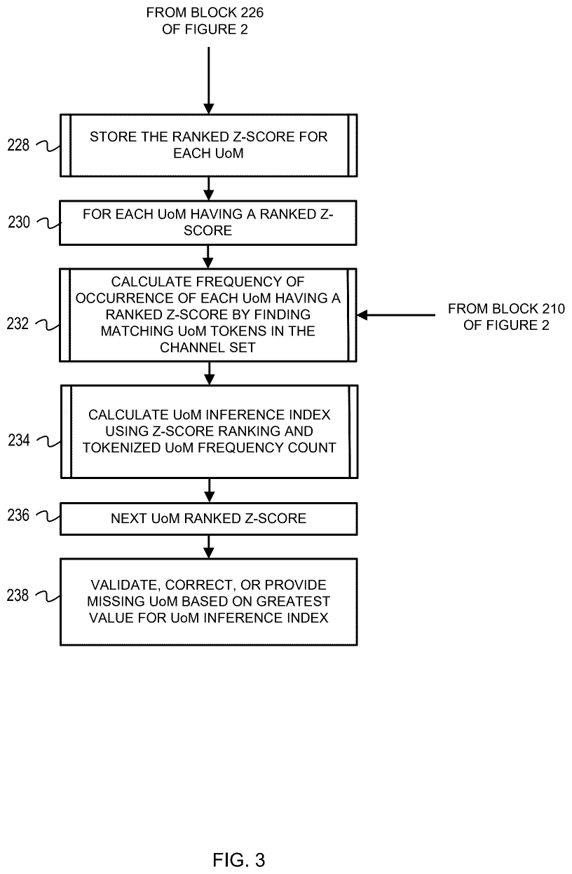

In some implementations, the well system 100 (e.g., such as the computer system 110 and/or other components of the well system 100) may access the historical database (either locally or stored remotely, such as in the remote monitoring site 180) to find historical measurement mnemonics that are similar to each of the sample measurement mnemonics 154 of each measurement channel 152 of the channel set 150. The well system 100 may perform the same operations for the other channel sets. In some implementations, the well system 100 may use natural language processing (NLP) techniques to find historical measurement channels or curves with similar linguistic mnemonics to the sample measurement channels 152. As shown in FIG. 1, one of the measurement channels 152 of the channel set 150 is data that has a measurement mnemonic 154 for hook load average (HKLDAV). The well system 100 may tokenize the data and use NLP techniques to find similar linguistic mnemonics that phonetically sound and/or are written similar to the “HKLDAV” mnemonic. In this example, the well system 100 may find datasets of historical measurement channels that use mnemonics that are linguistically similar to the “HKLDAV” mnemonic, such as the “HKLA” mnemonic and the “hkldAv1” mnemonic (e.g., see operation 161). Different mnemonics (e.g., having different spellings) for the same well metric or phenomenon may be used by different well sites or operators or customers. In some implementations, the well system 100 may also determine the UoM that is used for each historical measurement channel having the HKLA mnemonic, the hkldAv1 mnemonic, and any other instances of the HKLDAV mnemonic in the historical measurement data (see operation 162). For example, the measurement channels (both the current sample and historical) that use the HKLDAV mnemonic may use Newton (N), kilopounds (klbs), and metric ton (mton) as units of measure, the historical measurement channels that use the HKLA mnemonic may use kilopound-force (klbf) and kilo-decanewton (kdaN) as units of measure, and the historical measurement channels that use the hkldAv1 mnemonic may use the klbf and kdaN as units of measure. Since there may be duplicate UoMs, the well system 100 may then consolidate the different units of measure into the each distinct UoM (see operation 163). In this example, the distinct UoM may be N, klbs, mton, klbf, and kdaN. For similar measurement channels, the distinct UoM may be of the same class or type of UoM, even if the UoM are different. For example, the same class or type of UoM may be related to force or weight. Other measurement channels of the channel set may be other classes or types of UoM, such as speed, distance, length or rotation measurements. Thus, the well system 100 may use the sample measurement channel mnemonics to identify historically-relevant datasets and UoMs from the historical database. In some implementations, to find matching mnemonics from the historical database, the well system 100 may use network graphs and clusters and a similarity index with similarity thresholds, as further described in FIGS. 2-3.

In some implementations, the well system 100 may perform statistical analysis and comparison of the sample measurement data of the selected sample measurement channel, such as the sample measurement channel having the HKLDAV mnemonic, to the historical measurement data of the HKLA mnemonic, the hkldAv1 mnemonic, and any other instances of the HKLDAV mnemonic in the historical measurement data. For example, the well system 100 may calculate and rank z-scores of the data of the sample measurement channel having the HKLDAV mnemonic and compare it against the z-scores of each of the data of the historical measurement channels having the HKLA mnemonic, the hkldAv1 mnemonic, and any other instances of the HKLDAV mnemonic by distinct UoM. The well system 100 may calculate and rank the z-scores of the sample curve mean associated with the selected sample measurement channel against each historical curve population by distinct UoM, which is further described in FIGS. 2-3. The z-score analysis may look at the mean and the standard deviation of the datasets to determine how well the historical measurement data fits with the sample measurement data. The z-scores may then be ranked and the highest z-scores may indicate the historical measurement data that fits best with the sample measurement data. For example, the historical measurement data with the highest z-score may have the highest probability to match the sampled measurement data. After the z-score statistical analysis, the well system 100 may store the ranked z-scores.

In some implementations, the well system 100 may also determine a frequency of occurrence for each of the distinct UoMs (determined above) across all of the sample measurement channels 152 of the channel set 150. In the example described above, the sample measurement channel having the HKLDAV mnemonic has a UoM of Newtons (N), and the historical measurement channels have UoMs of N, klbs, mton, klbf, and kdaN. The well system 100 may reference the UoMs of all of the sample measurement channels 152 of the channel set 150 to determine the frequency of occurrence of the following UoMs: N, klbs, mton, klbf, and kdaN. In the channel set 150, the frequency of occurrence of N is a count of 2. The frequency of occurrence of klbs, mton, klbf, and kdaN is a count of 0. Thus, the frequency of occurrence analysis confirms that the UoM of the sample measurement channel having the HKLDAV mnemonic, which is N (Newtons), has a higher frequency of occurrence within the channel set 150 than the UoMs of the historical measurement channels. As another example, if the sample measurement mnemonic of rate of penetration (e.g., ROPA) has a UoM of meters per hour (m/h) and the historical measurement channels for ROPA also include a UoM of feet per hour (ft/h), the frequency of occurrence of the UoM of m/h (e.g., with a count of 1) in the channel set 150 would be higher than the frequency of occurrence of the UoM of ft/h (e.g., with a count of 0) in the channel set 150. In some implementations, a histogram may be generated that visually shows the frequency of occurrence results for each of the UoMs. In some implementations, the frequency of occurrence operation may also consider similar UoMs when determining the frequency of occurrence in a channel set. For example, if the UoM is m/h, the frequency of occurrence operation may also count the UoMs in the channel set 150 that have meters (m), meters cubed, and other metric UoMs that have meters as part of the UoM. Thus, the frequency of occurrence operation may also indicate whether a metric UoM may be more accurate than the English UoMs, or vice versa. As further described below, the well system 100 may use the frequency of occurrence results and/or the statistical analysis results from the historical-relevant datasets to validate or correct the UoMs of the sample measurement channels 152 of the channel set 150.

In some implementations, the well system 100 may use at least one of the frequency of occurrence results or the statistical analysis results from the historical-relevant datasets (e.g., z-score rankings) to validate or correct the UoMs of the sample measurement channels 152 of the channel set 150. In some implementations, the well system 100 may use a combination of the frequency of occurrence results and the statistical analysis results from the historical-relevant datasets to validate or correct the UoMs of the sample measurement channels 152 of the channel set 150. For example, based on the statistical results and the frequency of occurrence results described above, the UoM of the sample measurement channel having the HKLDAV mnemonic can be validated as a correct UoM for the corresponding sample measurement channel. The well system 100 may perform the same operations to validate or correct the UoM of the other sample measurement channels 152 of the channel set 150. When the well system 100 validates the UoM for a sample measurement channel, the well system 100 keeps the sample UoM. When the well system 100 corrects the UoM for a sample measurement channel, the well system 100 may replace the sample UoM with a different UoM, or may add in a missing UoM. For example, the well system 100 may replace the sample UoM with a different UoM that had statistical results above a threshold and/or had the highest frequency of occurrence. In some implementations, when a combination of the frequency of occurrence results and the statistical analysis results from the historical-relevant datasets are used to validate or correct the UoMs of the sample measurement channels 152 of the channel set 150, weights may be applied to both the frequency of occurrence results and the statistical results to provide different weightings or equal weightings to the individual results to derive the combined results. The combined results derived from the combination of the frequency of occurrence results and the statistical results may be referred to as a UoM inference index that is used to infer the accuracy of the sample UoM from the sample measurement channel, as further described in FIGS. 2-3. In some implementations, a similar process as described above can also be implemented for a multi-variant analysis of UoM defined to validation assumptions. For example, the process may check if the UoM is correct but the mnemonic is incorrect, and the mnemonic may be validated or corrected.

In some implementations, the validation and correction process may be fully automated or partially automated. For example, when fully automated, the frequency of occurrence operations and the statistical analysis operations may be automated to generate the results, and the validation and correction process may also be automated. As another example, when partially automated, the frequency of occurrence operations and the statistical analysis operations may be automated to generate the results, and the validation and correction process may be manual or partially manual. For example, the results may trigger a flag or an alert, and the operator or other user may manually correct a UoM that was deemed invalid.

FIG. 2 is a flowchart 200 of example operations for implementing an automated unit of measure management and validation system, according to some implementations.

At block 202 of FIG. 2, the well system 100 begins the UoM validation process for a channel set (such as the channel set 150 shown in FIG. 1). For example, the computer system 110 of the well system 100 begins the UoM validation process. At block 204, for each sample measurement channel (such as the sample measurement channels 152 shown in FIG. 1) in the channel set, a process loop may be initiated to tokenize data associated with each sample measurement channel. At block 206, the well system 100 may segment the channel name, mnemonics, and UoM. For example, the channel name, mnemonics, and UoM may be segmented in preparation for tokenization. At block 208, the channel name and mnemonics may be tokenized, and at block 210, the UoM may be tokenized. At block 212, the tokenization is performed on the next sample measurement channel, and the tokenization process loop continues until the corresponding data of all of the sample measurement channels are tokenized.

At block 214, the well system 100 may generate a network graph from the sample measurement channel tokens to the historical measurement channel tokens. For example, the network graph may be generated from the mnemonics tokens of the sample measurement channels and the mnemonics tokens of the historical measurement channels. A similarity index may be calculated between the sample mnemonics and the historical mnemonics, and the edges of the network graph may represent the similarity index between the mnemonics. At block 216, the well system 100 may detect similar network graph clusters that have a similarity index above a threshold. In some implementations, the threshold for the similarity index may be implemented using NLP and may indicate the degree of similarity (e.g., phonetic similarities) between the mnemonics. In some implementations, a similarity index threshold may be raised to reveal network graph clusters that have similar mnemonics associated with the same metric or phenomenon, such as the historical mnemonics that are similar (e.g., phonetically similar) to the sample mnemonics. At block 218, for each network cluster in the network graph, a process loop is initiated, and at block 220, an inner process loop is initiated for each UoM in each network cluster to perform statistical analysis on the UoMs. At block 222, the well system 100 may calculate and rank a z-score for each UoM option (e.g., each of the sample and historical UoMs) using historical channel mean and standard deviation against the mean of the sample channel (as the observed value). At block 224, the z-score is calculated and ranked for the next UoM, and the loop continues until the z-score has been calculated and ranked for all of the UoMs of a network cluster. At block 226, the process loops until all of the same z-score calculations and rankings are performed for each of the UoMs of the next network cluster, and this continues until all the process completes for all of the network clusters.

FIG. 3 is a continuation of the flowchart 200 that includes example operations for implementing an automated unit of measure management and validation system. At block 228 of FIG. 3, the well system 100 stores the ranked z-score for each of the UoMs. At block 230, the well system 100 initiates a process loop for each of the UoMs having a ranked z-scores to determine the frequency of occurrence of each UoM. At block 232, the well system 100 may calculate a frequency of occurrence for each UoM having a ranked z-score by finding matching UoM tokens in the channel set. For example, in the example described in FIG. 1, the sample measurement channel having the HKLDAV mnemonic has a UoM of Newtons (N), and the historical measurement channels have UoMs of N, klbs, mton, klbf, and kdaN. The well system 100 may reference the UoMs of all of the sample measurement channels of the channel set to determine the frequency of occurrence of the following UoMs: N, klbs, mton, klbf, and kdaN. In one example, the frequency of occurrence of N may be a count of 2, and the frequency of occurrence of klbs, mton, klbf, and kdaN may be a count of 0.

At block 234, the well system may calculate a UoM inference index using the UoM z-score rankings and the tokenized UoM frequency of occurrence count. In some implementations, the UoM inference index may be determined based on the combination of both the UoM z-score rankings and the UoM frequency of occurrence count. As described above in FIG. 1, in some implementations, equal or unequal weighting may be added to the UoM z-score rankings and the UoM frequency of occurrence count to determine the UoM inference index. At block 236, the process loops to determine the UoM inference index for the next UoM of the channel set having a ranked z-score. At block 238, the well system 100 may validate, correct, or provide missing UoM information based on the greatest value for the UoM inference index. The UoM inference index may be used to validate whether the sample UoM is accurate or whether the sample UoM needs to be corrected. The well system 100 may also determine whether the sample measurement channel has missing UoM information.

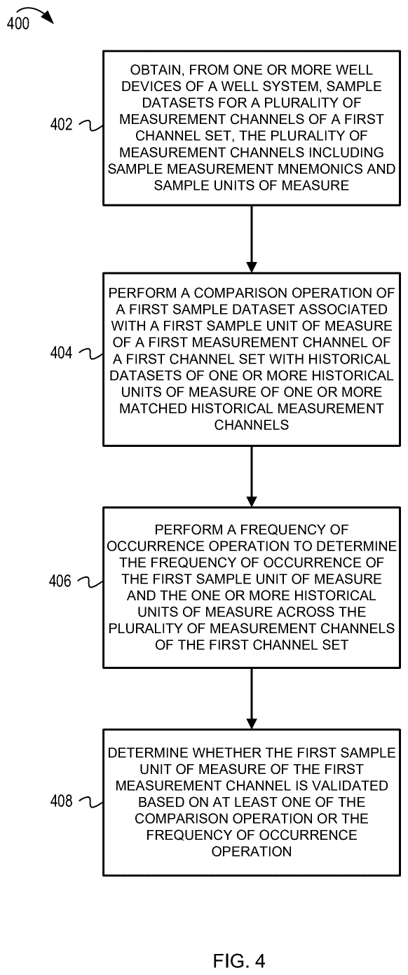

FIG. 4 is a flowchart 400 of example operations for implementing an automated unit of measure management and validation system, according to some implementations. In some implementations, sample datasets for a plurality of measurement channels of a first channel set may be obtained from one or more well devices of a well system. The plurality of measurement channels may include sample measurement mnemonics and sample units of measure (block 402). In some implementations, a comparison operation may be performed of a first sample dataset associated with a first sample unit of measure of a first measurement channel of a first channel set with historical datasets of one or more historical units of measure of one or more matched historical measurement channels (block 404). In some implementations, a frequency of occurrence operation may be performed to determine the frequency of occurrence of the first sample unit of measure and the one or more historical units of measure across the plurality of measurement channels of the first channel set (block 406). A determination may be made as to whether the first sample unit of measure of the first measurement channel is validated based on at least one of the comparison operation or the frequency of occurrence operation (block 408).

In some implementations, based on the sample measurement mnemonic of the first measurement channel, NLP may be performed on a plurality of historical measurement mnemonics of a plurality of historical measurement channels to determine the one or more historical measurement mnemonics that match the sample measurement mnemonic of the first measurement channel. In some implementations, the comparison operation may include determining one or more historical measurement mnemonics of one or more historical measurement channels match a sample measurement mnemonic of the first measurement channel of the first channel set, and comparing the first sample unit of measure of the first measurement channel with the one or more historical units of measure of the one or more matched historical measurement channels. In some implementations, the comparison operation of the first sample unit of measure of the first measurement channel with the one or more historical units of measure of the one or more matched historical measurement channels may include performing statistical analysis to compare the first sample dataset of the first sample unit of measure with the historical datasets of the one or more historical units of measure, and calculating and ranking z-scores indicating how closely statistics associated with the historical datasets of the one or more historical units of measure match with statistics of the first sample dataset of the first sample unit of measure.

In some implementations, it is determined whether the first sample unit of measure of the first measurement channel is validated based on a combination of a result of the comparison operation and a result of the frequency of occurrence operation. In some implementations, it is the determination may include determining a unit of measure inference index based on a combination of a result of the comparison operation and a result of the frequency of occurrence operation, and determining whether the first sample unit of measure of the first measurement channel is validated based on the unit of measure inference index. In some implementations, if the first sample unit of measure of the first measurement channel is validated, a confirmation may be provided that the first sample unit of measure of the first measurement channel is a valid unit of measure. If the first sample unit of measure of the first measurement channel is not validated, a replacement unit of measure from the one or more historical units of measure may be provided.

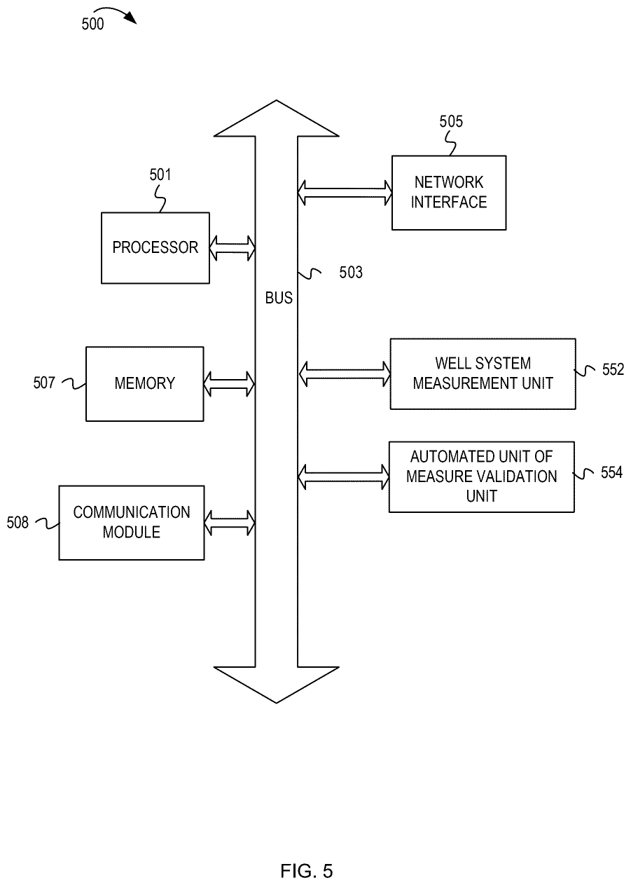

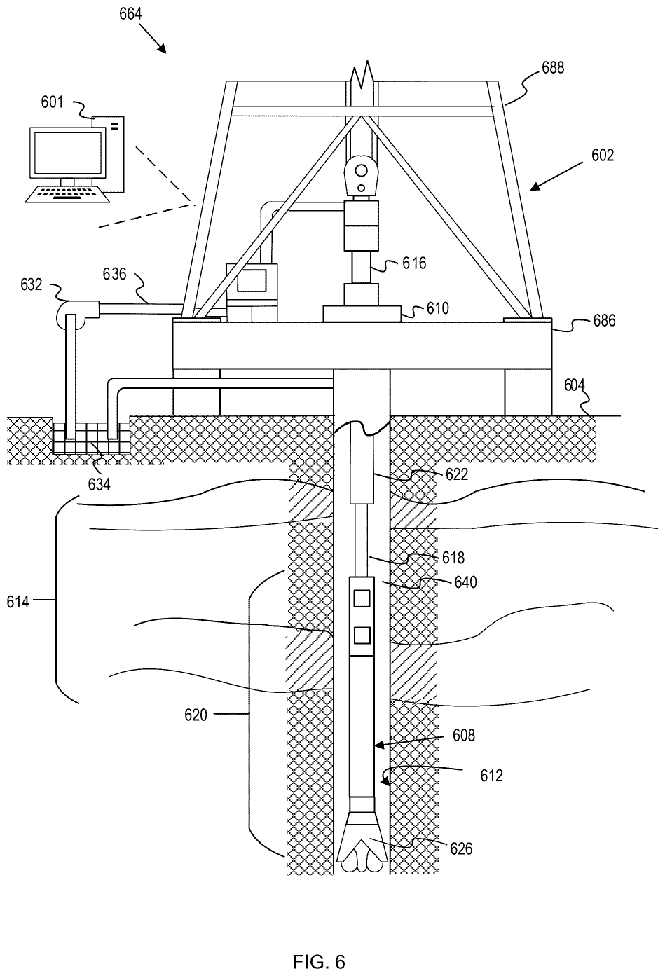

FIG. 5 depicts an example computer system that can be implemented in surface equipment of a well system for implementing an automated unit of measure management and validation system, according to some implementations. The computer system 500 may be an example of a computer system that may be used during the operation of the well system, such as the computer system 110 shown in FIG. 1 and computer system 601 shown in FIG. 6. For example, the computer system 500 may be a standalone computer system (such as a workstation, laptop, or desktop) or may be integrated into other surface equipment of the well system. The computer system 500 may include one or more processors 501 (possibly including multiple cores, multiple nodes, and/or implementing multi-threading, etc.). The computer system 500 may include memory 507. The memory 507 may be system memory or any type or implementation of machine or computer readable media having instructions that are executable by the one or more processors 501 to implement the operations described in FIGS. 1-4. The memory 507 may be system memory or any type or implementation of machine or computer readable and writable media having the ability to receive, process and/or store measurement data from well devices and tools (including those described in FIGS. 1-6). The computer system 500 also may include a bus 503 and a network interface 505. The computer system 500 also may include a communications module 508 that may control wired and wireless communications, such as communicating with downhole devices or tools and communicating with other surface equipment. The computer system 500 also may include at least a well system measurement unit 552 and an automated unit of measure validation unit 554, among other processing units or modules that are used during the operation of the well system and the well tools described herein. For example, the well system measurement unit 552 may control above ground and downhole equipment and tools to obtain measurement data, and may process store the measurement data including measurement channel data for channel sets, as described in FIGS. 1-4. The automated unit of measure validation unit 554 may implement the statistical analysis operations, the frequency of occurrence operations, and the validation and correction operations, and other related operations for the UoM validation system, as described above in FIGS. 1-4. The functionality described herein may be implemented with an application-specific integrated circuit, in logic implemented in the processor(s) 501, in a co-processor on a peripheral device or card, etc. Further, implementations may include fewer or additional components not illustrated in FIG. 5. The processor(s) 501 and the network interface 505 may be coupled to the bus 503. Although illustrated as being coupled to the bus 503, the memory 507 may be coupled to the processor(s) 501.

FIG. 6 is a schematic diagram of a drilling rig system as an example of oil services systems that use surface and downhole equipment, according to some implementations. For example, in FIG. 6 it can be seen how a system 664 may also form a portion of a drilling rig 602 located at the surface 604 of a well. It is noted that while drilling system 664 may be illustrated as land-based, the present techniques may also be applicable in offshore applications. Drilling of oil and gas wells is commonly carried out using a string of drill pipes connected together so as to form a drilling string 608 that may be lowered through a rotary table 610 into a borehole 612. Here a drilling platform 686 may be equipped with a derrick 688 that supports a hoist. A computer system 601 may be communicatively coupled to any sensors, control devices, and tools attached to surface equipment or to the downhole equipment (e.g., downhole well devices and downhole well tools) of the system 664. As described above in FIGS. 1 and 5, the computer system 601 may implement the automated unit of measure management and validation system and the various corresponding operations described herein in FIGS. 1-5.

The drilling rig 602 may provide support for the drill string 608. The drill string 608 may operate to penetrate the rotary table 610 for drilling the borehole 612 through subsurface formations 614. The drill string 608 may include a Kelly 616, drill pipe 618, and a bottom hole assembly 620, perhaps located at the lower portion of the drill pipe 618.

The bottom hole assembly 620 may include drill collars 622, one or more downhole tools (including the downhole imaging tool 60), and a drill bit 626. The drill bit 626 may operate to create a borehole 612 by penetrating the surface 604 and subsurface formations 614. The one or more additional downhole tools may comprise any of a number of different types of tools including MWD tools, LWD tools, and others.

During drilling operations, the drill string 608 (perhaps including the Kelly 616, the drill pipe 618, and the bottom hole assembly 620) may be rotated by the rotary table 610. In addition to, or alternatively, the bottom hole assembly 620 may also be rotated by a motor (e.g., a mud motor) that may be located downhole. The drill collars 622 may be used to add weight to the drill bit 626. The drill collars 622 may also operate to stiffen the bottom hole assembly 620, allowing the bottom hole assembly 620 to transfer the added weight to the drill bit 626, and in turn, to assist the drill bit 626 in penetrating the surface 604 and subsurface formations 614.

Drilling operations may utilize various surface equipment, such as a mud pump 632 or other types of surface equipment. The surface equipment may be outfitted with one or more sensors and one or more control devices. During drilling operations, the mud pump 632 may pump drilling fluid (sometimes known by those of ordinary skill in the art as “drilling mud”) from a mud pit 634 through a hose 636 into the drill pipe 618 and down to the drill bit 626. In some implementations, one or more sensors may monitor one or more metrics of the pump drilling fluid (such as flow rate), and one or more control devices may control one or more operations of the mud pump 632 (such as opening and closing one or more valves or other mechanisms). The drilling fluid may flow out from the drill bit 626 and be returned to the surface 604 through an annular area 640 between the drill pipe 618 and the sides of the borehole 612. The drilling fluid may then be returned to the mud pit 634, where such fluid may be filtered. In some embodiments, the drilling fluid may be used to cool the drill bit 626, as well as to provide lubrication for the drill bit 626 during drilling operations. Additionally, the drilling fluid may be used to remove subsurface formation 614 cuttings created by operating the drill bit 626. It may be the images of these cuttings that many implementations operate to acquire and process.

Although an example well system is shown in FIG. 6, it is noted, however, that the automated unit of measure management and validation system described in FIGS. 1-5 can be used in any type of well system in the oil and gas industry. For example, the well systems may be any type of drilling well systems, completion well systems, and producing well systems.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

While the aspects of the disclosure are described with reference to various implementations and exploitations, it will be understood that these aspects are illustrative and that the scope of the claims is not limited to them. In general, techniques for implementing an automated unit of measure management and validation system as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

Furthermore, unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

### Example Embodiments

Example Embodiments can include the following:

Embodiment #1: A method for validating well system measurements, comprising: obtaining, from one or more well devices of a well system, sample datasets for a plurality of measurement channels of a first channel set, the plurality of measurement channels including sample measurement mnemonics and sample units of measure; performing a comparison operation of a first sample dataset associated with a first sample unit of measure of a first measurement channel of a first channel set with historical datasets of one or more historical units of measure of one or more matched historical measurement channels; performing a frequency of occurrence operation to determine the frequency of occurrence of the first sample unit of measure and the one or more historical units of measure across the plurality of measurement channels of the first channel set; and determining whether the first sample unit of measure of the first measurement channel is validated based on at least one of the comparison operation or the frequency of occurrence operation.

Embodiment #2: The method of Embodiment #1, wherein performing the comparison operation of the first sample dataset associated with the first sample unit of measure of the first measurement channel of the first channel set with the historical datasets of one or more historical units of measure of one or more matched historical measurement channels includes: determining one or more historical measurement mnemonics of one or more historical measurement channels match a sample measurement mnemonic of the first measurement channel of the first channel set; and comparing the first sample unit of measure of the first measurement channel with the one or more historical units of measure of the one or more matched historical measurement channels.

Embodiment #3: The method of Embodiment #2, wherein determining one or more historical measurement mnemonics of one or more historical measurement channels match the sample measurement mnemonic of the first measurement channel of the first channel set includes: performing, based on the sample measurement mnemonic of the first measurement channel, natural language processing (NLP) on a plurality of historical measurement mnemonics of a plurality of historical measurement channels to determine the one or more historical measurement mnemonics that match the sample measurement mnemonic of the first measurement channel.

Embodiment #4: The method of Embodiment #2, wherein comparing the first sample unit of measure of the first measurement channel with the one or more historical units of measure of the one or more matched historical measurement channels includes: performing statistical analysis to compare the first sample dataset of the first sample unit of measure with the historical datasets of the one or more historical units of measure; and calculating and ranking z-scores indicating how closely statistics associated with the historical datasets of the one or more historical units of measure match with statistics of the first sample dataset of the first sample unit of measure.

Embodiment #5: The method of Embodiment #1, further comprising: determining whether the first sample unit of measure of the first measurement channel has a higher frequency of occurrence across the plurality of measurement channels of the first channel set than the one or more historical units of measure.

Embodiment #6: The method of Embodiment #1, wherein determining whether the first sample unit of measure of the first measurement channel is validated based on at least one of the comparison operation or the frequency of occurrence operation includes: determining whether the first sample unit of measure of the first measurement channel is validated based on a combination of a result of the comparison operation and a result of the frequency of occurrence operation.

Embodiment #7: The method of Embodiment #1, wherein determining whether the first sample unit of measure of the first measurement channel is validated based on at least one of the comparison operation or the frequency of occurrence operation includes: determining a unit of measure inference index based on a combination of a result of the comparison operation and a result of the frequency of occurrence operation; and determining whether the first sample unit of measure of the first measurement channel is validated based on the unit of measure inference index.

Embodiment #8: The method of Embodiment #1, further comprising: if the first sample unit of measure of the first measurement channel is validated, provide a confirmation that the first sample unit of measure of the first measurement channel is a valid unit of measure; or if the first sample unit of measure of the first measurement channel is not validated, provide a replacement unit of measure from the one or more historical units of measure.

Embodiment #9: The method of Embodiment #1, further comprising: performing a comparison operation of a second sample dataset associated with a second sample unit of measure of a second measurement channel of the first channel set with historical datasets of one or more historical units of measure of one or more matched historical measurement channels; performing a frequency of occurrence operation to determine the frequency of occurrence of the second sample unit of measure and the one or more historical units of measure across the plurality of measurement channels of the first channel set; and determining whether the second sample unit of measure of the second measurement channel is validated based on at least one of the comparison operation or the frequency of occurrence operation.

Embodiment #10: The method of Embodiment #1, wherein the one or more well devices of the well system include at least one of surface equipment, surface well tools, or downhole well tools.

Embodiment #11: A well system, comprising: one or more processors; and a computer-readable storage medium having instructions stored thereon that are executable by the one or more processors to cause the well system to: obtain, from one or more well devices, sample datasets for a plurality of measurement channels of a first channel set, the plurality of measurement channels including sample measurement mnemonics and sample units of measure; perform a comparison operation of a first sample dataset associated with a first sample unit of measure of a first measurement channel of a first channel set with historical datasets of one or more historical units of measure of one or more matched historical measurement channels; perform a frequency of occurrence operation to determine the frequency of occurrence of the first sample unit of measure and the one or more historical units of measure across the plurality of measurement channels of the first channel set; and determine whether the first sample unit of measure of the first measurement channel is validated based on at least one of the comparison operation or the frequency of occurrence operation.

Embodiment #12: The well system of Embodiment #11, wherein the instructions that cause the well system to perform the comparison operation include instructions to cause the well system to: determine one or more historical measurement mnemonics of one or more historical measurement channels match a sample measurement mnemonic of the first measurement channel of the first channel set; and compare the first sample unit of measure of the first measurement channel with the one or more historical units of measure of the one or more matched historical measurement channels.

Embodiment #13: The well system of Embodiment #12, wherein the instructions that cause the well system to determine one or more historical measurement mnemonics of one or more historical measurement channels match the sample measurement mnemonic of the first measurement channel of the first channel set includes instructions to cause the well system to: perform, based on the sample measurement mnemonic of the first measurement channel, natural language processing (NLP) on a plurality of historical measurement mnemonics of a plurality of historical measurement channels to determine the one or more historical measurement mnemonics that match the sample measurement mnemonic of the first measurement channel.

Embodiment #14: The well system of Embodiment #12, wherein the instructions that cause the well system to compare the first sample unit of measure of the first measurement channel with the one or more historical units of measure of the one or more matched historical measurement channels includes instructions to cause the well system to: perform statistical analysis to compare the first sample dataset of the first sample unit of measure with the historical datasets of the one or more historical units of measure; and calculate and rank z-scores indicating how closely statistics associated with the historical datasets of the one or more historical units of measure match with statistics of the first sample dataset of the first sample unit of measure.

Embodiment #15: The well system of Embodiment #11, wherein the instructions that cause the well system to determine whether the first sample unit of measure of the first measurement channel is validated based on at least one of the comparison operation or the frequency of occurrence operation includes instructions to cause the well system to: determine a unit of measure inference index based on a combination of a result of the comparison operation and a result of the frequency of occurrence operation; and determine whether the first sample unit of measure of the first measurement channel is validated based on the unit of measure inference index.

Embodiment #16: A non-transitory computer-readable storage medium having instructions stored thereon that are executable by one or more processors of a well system, the instructions comprising: instructions for obtaining, from one or more well devices of the well system, sample datasets for a plurality of measurement channels of a first channel set, the plurality of measurement channels including sample measurement mnemonics and sample units of measure; instructions for performing a comparison operation of a first sample dataset associated with a first sample unit of measure of a first measurement channel of a first channel set with historical datasets of one or more historical units of measure of one or more matched historical measurement channels; instructions for performing a frequency of occurrence operation to determine the frequency of occurrence of the first sample unit of measure and the one or more historical units of measure across the plurality of measurement channels of the first channel set; and instructions for determining whether the first sample unit of measure of the first measurement channel is validated based on at least one of the comparison operation or the frequency of occurrence operation.

Embodiment #17: The non-transitory computer-readable storage medium of Embodiment #16, wherein the instructions for performing the comparison operation include: instructions for determining one or more historical measurement mnemonics of one or more historical measurement channels match a sample measurement mnemonic of the first measurement channel of the first channel set; and instructions for comparing the first sample unit of measure of the first measurement channel with the one or more historical units of measure of the one or more matched historical measurement channels.

Embodiment #18: The non-transitory computer-readable storage medium of Embodiment #17, wherein the instructions for determining one or more historical measurement mnemonics of one or more historical measurement channels match the sample measurement mnemonic of the first measurement channel of the first channel set includes: instructions for performing, based on the sample measurement mnemonic of the first measurement channel, natural language processing (NLP) on a plurality of historical measurement mnemonics of a plurality of historical measurement channels to determine the one or more historical measurement mnemonics that match the sample measurement mnemonic of the first measurement channel.

Embodiment #19: The non-transitory computer-readable storage medium of Embodiment #16, wherein the instructions for comparing the first sample unit of measure of the first measurement channel with the one or more historical units of measure of the one or more matched historical measurement channels includes: instructions for performing statistical analysis to compare the first sample dataset of the first sample unit of measure with the historical datasets of the one or more historical units of measure; and instructions for calculating and ranking z-scores indicating how closely statistics associated with the historical datasets of the one or more historical units of measure match with statistics of the first sample dataset of the first sample unit of measure.

Embodiment #20: The non-transitory computer-readable storage medium of Embodiment #16, wherein the instructions for determining whether the first sample unit of measure of the first measurement channel is validated based on at least one of the comparison operation or the frequency of occurrence operation includes: instructions for determining a unit of measure inference index based on a combination of a result of the comparison operation and a result of the frequency of occurrence operation; and instructions for determining whether the first sample unit of measure of the first measurement channel is validated based on the unit of measure inference index.

What is claimed is:

1. A method for validating well system measurements, comprising:
obtaining, from one or more well devices of a well system, sample datasets for a plurality of measurement channels of a first channel set, the plurality of measurement channels including sample measurement mnemonics and sample units of measure;
performing a comparison operation of a first sample dataset associated with a first sample unit of measure of a first measurement channel of a first channel set with historical datasets of one or more historical units of measure of one or more matched historical measurement channels;
performing a frequency of occurrence operation to determine the frequency of occurrence of the first sample unit of measure and the one or more historical units of measure across the plurality of measurement channels of the first channel set; and
determining whether the first sample unit of measure of the first measurement channel is validated based on at least one of the comparison operation or the frequency of occurrence operation.

2. The method of claim 1, wherein performing the comparison operation of the first sample dataset associated with the first sample unit of measure of the first measurement channel of the first channel set with the historical datasets of one or more historical units of measure of one or more matched historical measurement channels includes:
determining one or more historical measurement mnemonics of one or more historical measurement channels match a sample measurement mnemonic of the first measurement channel of the first channel set; and
comparing the first sample unit of measure of the first measurement channel with the one or more historical units of measure of the one or more matched historical measurement channels.

3. The method of claim 2, wherein determining one or more historical measurement mnemonics of one or more historical measurement channels match the sample measurement mnemonic of the first measurement channel of the first channel set includes:
performing, based on the sample measurement mnemonic of the first measurement channel, natural language processing (NLP) on a plurality of historical measurement mnemonics of a plurality of historical measurement channels to determine the one or more historical measurement mnemonics that match the sample measurement mnemonic of the first measurement channel.

4. The method of claim 2, wherein comparing the first sample unit of measure of the first measurement channel with the one or more historical units of measure of the one or more matched historical measurement channels includes:
performing statistical analysis to compare the first sample dataset of the first sample unit of measure with the historical datasets of the one or more historical units of measure; and
calculating and ranking z-scores indicating how closely statistics associated with the historical datasets of the one or more historical units of measure match with statistics of the first sample dataset of the first sample unit of measure.

5. The method of claim 1, further comprising:
determining whether the first sample unit of measure of the first measurement channel has a higher frequency of occurrence across the plurality of measurement channels of the first channel set than the one or more historical units of measure.

6. The method of claim 1, wherein determining whether the first sample unit of measure of the first measurement channel is validated based on at least one of the comparison operation or the frequency of occurrence operation includes:
determining whether the first sample unit of measure of the first measurement channel is validated based on a combination of a result of the comparison operation and a result of the frequency of occurrence operation.

7. The method of claim 1, wherein determining whether the first sample unit of measure of the first measurement channel is validated based on at least one of the comparison operation or the frequency of occurrence operation includes:
determining a unit of measure inference index based on a combination of a result of the comparison operation and a result of the frequency of occurrence operation; and
determining whether the first sample unit of measure of the first measurement channel is validated based on the unit of measure inference index.

8. The method of claim 1, further comprising:
if the first sample unit of measure of the first measurement channel is validated, providing a confirmation that the first sample unit of measure of the first measurement channel is a valid unit of measure; or
if the first sample unit of measure of the first measurement channel is not validated, providing a replacement unit of measure from the one or more historical units of measure.

9. The method of claim 1, further comprising:
performing a comparison operation of a second sample dataset associated with a second sample unit of measure of a second measurement channel of the first channel set with historical datasets of one or more historical units of measure of one or more matched historical measurement channels;
performing a frequency of occurrence operation to determine the frequency of occurrence of the second sample unit of measure and the one or more historical units of measure across the plurality of measurement channels of the first channel set; and
determining whether the second sample unit of measure of the second measurement channel is validated based on at least one of the comparison operation or the frequency of occurrence operation.

10. The method of claim 1, wherein the one or more well devices of the well system include at least one of surface equipment, surface well tools, or downhole well tools.

11. A well system, comprising:
one or more processors; and
a computer-readable storage medium having instructions stored thereon that are executable by the one or more processors to cause the well system to:
obtain, from one or more well devices, sample datasets for a plurality of measurement channels of a first channel set, the plurality of measurement channels including sample measurement mnemonics and sample units of measure;
perform a comparison operation of a first sample dataset associated with a first sample unit of measure of a first measurement channel of a first channel set with historical datasets of one or more historical units of measure of one or more matched historical measurement channels;
perform a frequency of occurrence operation to determine the frequency of occurrence of the first sample unit of measure and the one or more historical units of measure across the plurality of measurement channels of the first channel set; and
determine whether the first sample unit of measure of the first measurement channel is validated based on at least one of the comparison operation or the frequency of occurrence operation.

12. The well system of claim 11, wherein the instructions that cause the well system to perform the comparison operation include instructions to cause the well system to:
determine one or more historical measurement mnemonics of one or more historical measurement channels match a sample measurement mnemonic of the first measurement channel of the first channel set; and
compare the first sample unit of measure of the first measurement channel with the one or more historical units of measure of the one or more matched historical measurement channels.

13. The well system of claim 12, wherein the instructions that cause the well system to determine one or more historical measurement mnemonics of one or more historical measurement channels match the sample measurement mnemonic of the first measurement channel of the first channel set includes instructions to cause the well system to:
perform, based on the sample measurement mnemonic of the first measurement channel, natural language processing (NLP) on a plurality of historical measurement mnemonics of a plurality of historical measurement channels to determine the one or more historical measurement mnemonics that match the sample measurement mnemonic of the first measurement channel.

14. The well system of claim 12, wherein the instructions that cause the well system to compare the first sample unit of measure of the first measurement channel with the one or more historical units of measure of the one or more matched historical measurement channels includes instructions to cause the well system to:
perform statistical analysis to compare the first sample dataset of the first sample unit of measure with the historical datasets of the one or more historical units of measure; and
calculate and rank z-scores indicating how closely statistics associated with the historical datasets of the one or more historical units of measure match with statistics of the first sample dataset of the first sample unit of measure.

15. The well system of claim 11, wherein the instructions that cause the well system to determine whether the first sample unit of measure of the first measurement channel is validated based on at least one of the comparison operation or the frequency of occurrence operation includes instructions to cause the well system to:
determine a unit of measure inference index based on a combination of a result of the comparison operation and a result of the frequency of occurrence operation; and
determine whether the first sample unit of measure of the first measurement channel is validated based on the unit of measure inference index.

16. A non-transitory computer-readable storage medium having instructions stored thereon that are executable by one or more processors of a well system, the instructions comprising:
instructions for obtaining, from one or more well devices of the well system, sample datasets for a plurality of measurement channels of a first channel set, the plurality of measurement channels including sample measurement mnemonics and sample units of measure;
instructions for performing a comparison operation of a first sample dataset associated with a first sample unit of measure of a first measurement channel of a first channel set with historical datasets of one or more historical units of measure of one or more matched historical measurement channels;
instructions for performing a frequency of occurrence operation to determine the frequency of occurrence of the first sample unit of measure and the one or more historical units of measure across the plurality of measurement channels of the first channel set; and
instructions for determining whether the first sample unit of measure of the first measurement channel is validated based on at least one of the comparison operation or the frequency of occurrence operation.

17. The non-transitory computer-readable storage medium of claim 16, wherein the instructions for performing the comparison operation include:
instructions for determining one or more historical measurement mnemonics of one or more historical measurement channels match a sample measurement mnemonic of the first measurement channel of the first channel set; and
instructions for comparing the first sample unit of measure of the first measurement channel with the one or more historical units of measure of the one or more matched historical measurement channels.

18. The non-transitory computer-readable storage medium of claim 17, wherein the instructions for determining one or more historical measurement mnemonics of one or more historical measurement channels match the sample measurement mnemonic of the first measurement channel of the first channel set includes:
instructions for performing, based on the sample measurement mnemonic of the first measurement channel, natural language processing (NLP) on a plurality of historical measurement mnemonics of a plurality of historical measurement channels to determine the one or more historical measurement mnemonics that match the sample measurement mnemonic of the first measurement channel.

19. The non-transitory computer-readable storage medium of claim 17, wherein the instructions for comparing the first sample unit of measure of the first measurement channel with the one or more historical units of measure of the one or more matched historical measurement channels includes:
instructions for performing statistical analysis to compare the first sample dataset of the first sample unit of measure with the historical datasets of the one or more historical units of measure; and
instructions for calculating and ranking z-scores indicating how closely statistics associated with the historical datasets of the one or more historical units of measure match with statistics of the first sample dataset of the first sample unit of measure.

20. The non-transitory computer-readable storage medium of claim 16, wherein the instructions for determining whether the first sample unit of measure of the first measurement channel is validated based on at least one of the comparison operation or the frequency of occurrence operation includes:
instructions for determining a unit of measure inference index based on a combination of a result of the comparison operation and a result of the frequency of occurrence operation; and
instructions for determining whether the first sample unit of measure of the first measurement channel is validated based on the unit of measure inference index.
